(19) United States
(12) Patent Application Publication
(10) Pub. No.: US 2019/0070065 A1
(43) Pub. Date: Mar. 7, 2019

(54) BODY TREATMENT DEVICE

(71) Applicant: YEHEZKEL HIZKO HEN, LOD (IL)

(72) Inventor: YEHEZKEL HIZKO HEN, LOD (IL)

(21) Appl. No.: 16/175,862

(22) Filed: Oct. 31, 2018

Related U.S. Application Data
(63) Continuation-in-part of application No. 14/595,356, filed on Jan. 13, 2015.

(30) Foreign Application Priority Data
Jan. 29, 2014 (IL) 233951

(51) Int. Cl. A61H 15/00; A61H 39/04

(52) U.S. Cl. CPC A61H 15/0078; A61H 2205/125; A61H 2015/0014; A61H 39/04

(57) ABSTRACT

A body treatment device including a foot platform, a plurality of cylinders, a first mechanism, for rotating the plurality of cylinders, and a foot protection mechanism including a rear and front extendible supporting members.

### CROSS-REFERENCE TO RELATED APPLICATIONS

This application is a Continuation-in-Part of U.S. patent application Ser. No. 14/595,356, filed Jan. 13, 2015, which claims the benefit of priority of Jan. 29, 2014, of IL Patent Application No. 233951.

### TECHNICAL FIELD

The present invention relates to the field of body treatment devices. In particular, the present invention relates to the devices treating the body through the foot.

### BACKGROUND

Reflexology claims that the spine and other organs may be treated through the bottom surface of the foot.

It is an object of the present invention to provide an apparatus for treating the body through the bottom surface of the foot.

There is a long felt need to provide a solution to the above-mentioned and other problems of the prior art.

### SUMMARY

A body treatment device including a foot platform, a plurality of cylinders, a first mechanism, for rotating the plurality of cylinders, and a foot protection mechanism, including a rear and front extendible supporting members.

### BRIEF DESCRIPTION OF THE DRAWINGS

Embodiments, features, and aspects of the invention are described herein in conjunction with the following drawings:

FIG. 1 is a front view of a portion of a body treatment device according to one embodiment of the present invention.

FIG. 2 is a top view of three cylinders of FIG. 1.

FIG. 3 is a front view of the body treatment device of FIG. 1.

FIG. 4 is a front view of a portion of a body treatment device of FIG. 1, in operation of a first direction.

FIG. 5 is a front view of a portion of a body treatment device of FIG. 1, in operation of a second direction.

FIG. 6A depicts the cylinder of FIG. 1 according to one embodiment.

FIG. 6B depicts the cylinder of FIG. 1 according to another embodiment.

FIG. 7 is a perspective view of the body treatment device of FIG. 1.

FIG. 8 is a perspective view of the body treatment device of FIG. 1.

FIG. 9 is a perspective view of the body treatment device of FIG. 1 at a first folding step.

FIG. 10 is a perspective view of the body treatment device of FIG. 1 at the second folding step.

The drawings are not necessarily drawn to scale.

### DETAILED DESCRIPTION

The invention will be understood from the following detailed description of embodiments of the invention, which are meant to be descriptive and not limiting. For the sake of brevity, some well-known features are not described in detail.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

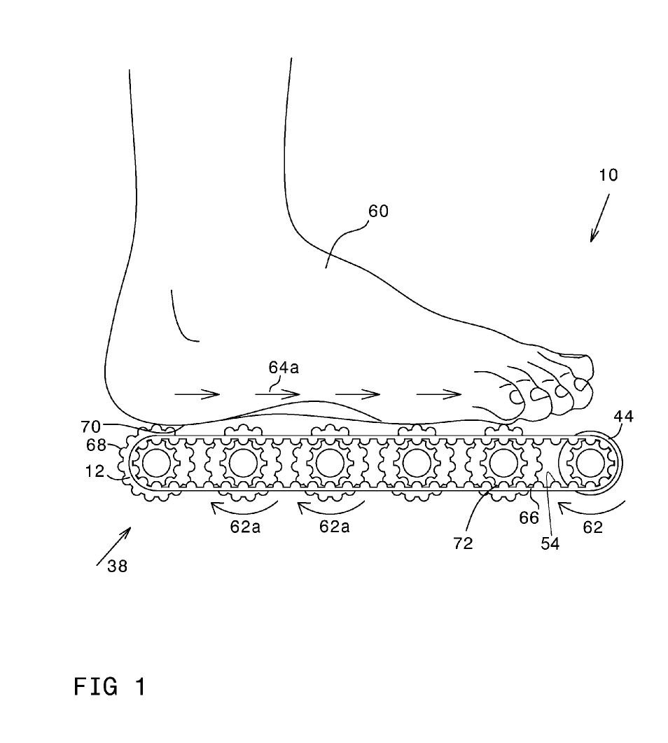

FIG. 1 is a front view of a portion of a body treatment device according to one embodiment of the present invention.

A body treatment device 10 includes a plurality of cylinders 12, disposed parallel one to the other, for being rotated by a cylinders rotating mechanism 38 against the weight of a user's bare foot 60 standing thereon, in touch therewith, bare or with socks.

Rotation of the external surfaces 68 of cylinders 12, all in the same angular direction, being angular direction 62A or against it, is intended for producing physical linear flow applied on the bottom surface 70 of foot 60, along linear direction 64A or against it. The physical flow may produce an internal blood flow, energy flow or other.

Cylinders rotating mechanism 38 includes a motor 44, and may include a strap 66 having cogs 54 for transferring the rotation of motor 44 to cylinders 12, for rotating cylinders 12, all in the same angular direction 62A or against it.

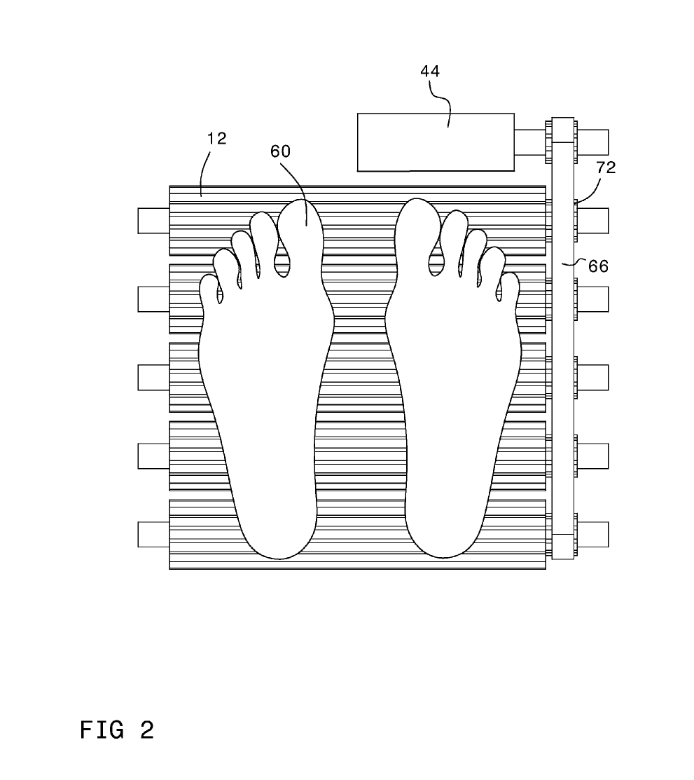

FIG. 2 is a top view of three cylinders of FIG. 1.

Each of cylinders 12 may include a gear 72, for being clasped by cogs 54 (enumerated in FIG. 1) of strap 66.

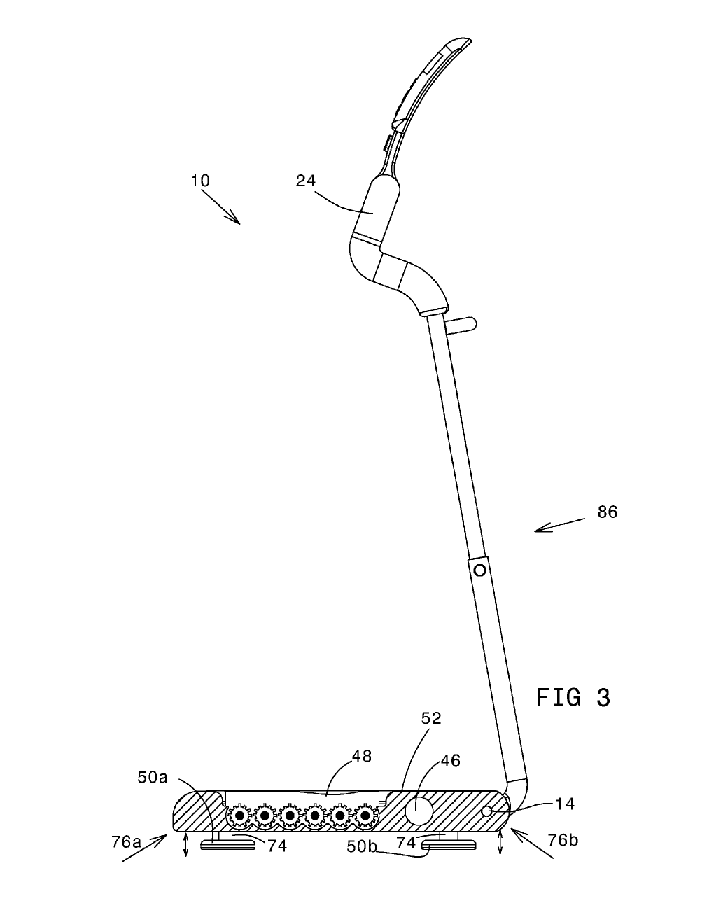

FIG. 3 is a front view of the body treatment device of FIG. 1.

Cylinders 12 are disposed within a platform 52 having one depression 48 for each foot. Depression 48 is disposed at the top, and the shape thereof is fitted to the shape of foot 60.

Platform 52 may further include a vibrator 46, for further vibrating the foot 60.

A rear extendible supporting member 50A supports the rear 76A of platform 52 to the ground; and a front extendible supporting member 50B supports the front 76B of platform 52 to the ground. Each of extendible supporting 50 includes a telescope 74, including hydraulic, pneumatic, or electric means for lifting the front 76 or the rear 78 of platform 52, one in relation to the other.

This lifting of the front or the rear of platform 52 tilts the foot 60, and thus produces gravity force.

A handle 24 extends from platform 52 to the height of the hands of the user, for being held thereby. The base 86 of handle 24 may be rotated in relation to platform, through pivotal connection 14, either upon lifting the front 76 or the rear 78 of platform 52.

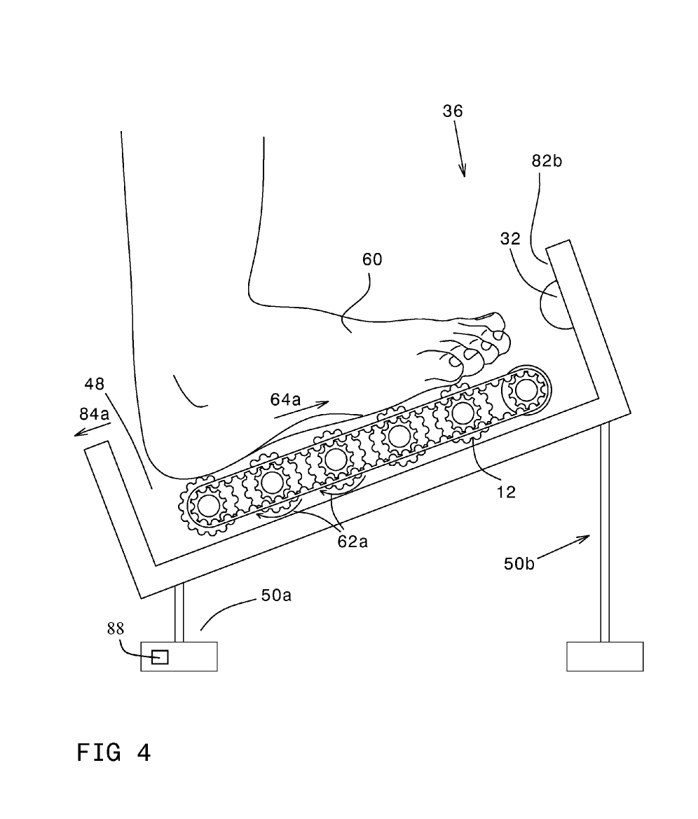

FIG. 4 is a front view of a portion of a body treatment device of FIG. 1, in operation of a first direction.

Upon rotation of cylinders along angular direction 62A which produces flow at the bottom surface 70 of foot 60, along linear direction 64A, the front of foot 60 might be pushed forward onto the front border 82B of depression 48. This pushing is not desirable, especially since the foot 60 is bare, thus might be hurt.

A foot protection mechanism 36 protects the front and the rear of the foot against pressure applied thereon. Foot protection mechanism 36 may include a padding 32 disposed on the front border 82B, and on the rear border 82A.

According to another embodiment, foot protection mechanism 36 includes front extendible supporting member 50B and a control module 88 of a control unit for controlling the supporting member.

A telescope 74 of front extendible supporting member 50B is being extended for lifting the front of foot 60 in relation to the rear, for producing gravity force 84A against the forward pushing.

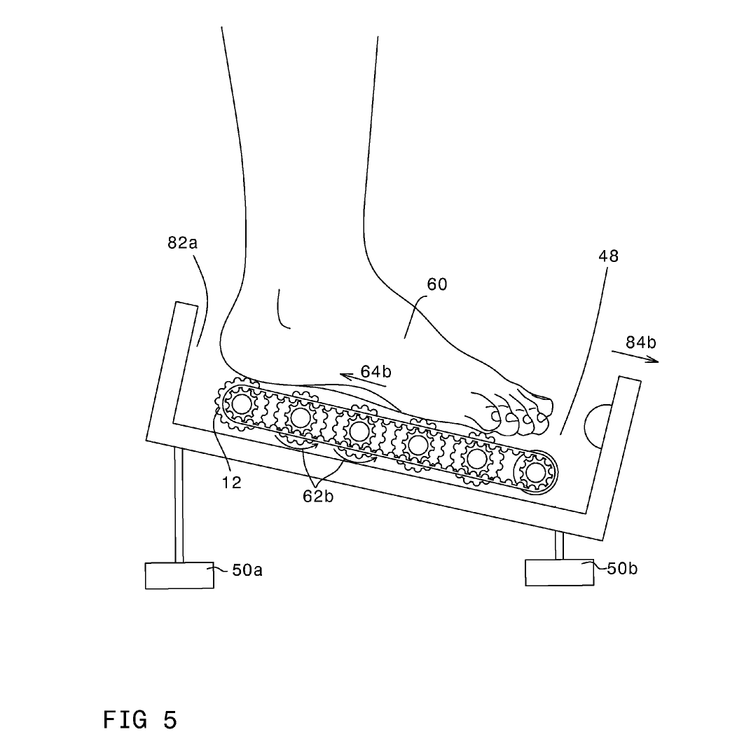

FIG. 5 is a front view of a portion of a body treatment device of FIG. 1, in operation of a second direction.

Upon rotation of cylinders along angular direction 62B which produces flow at the bottom surface 70 of foot 60, along linear direction 64B, the front of foot 60 might be pushed backward onto the rear border 82A of depression 48. In order to avoid this pushing, telescope 74 of rear extendible supporting member 50A is being extended for lifting the rear of foot 60 in relation to the front thereof, for producing gravity force 84B against the rear pushing of cylinders 12

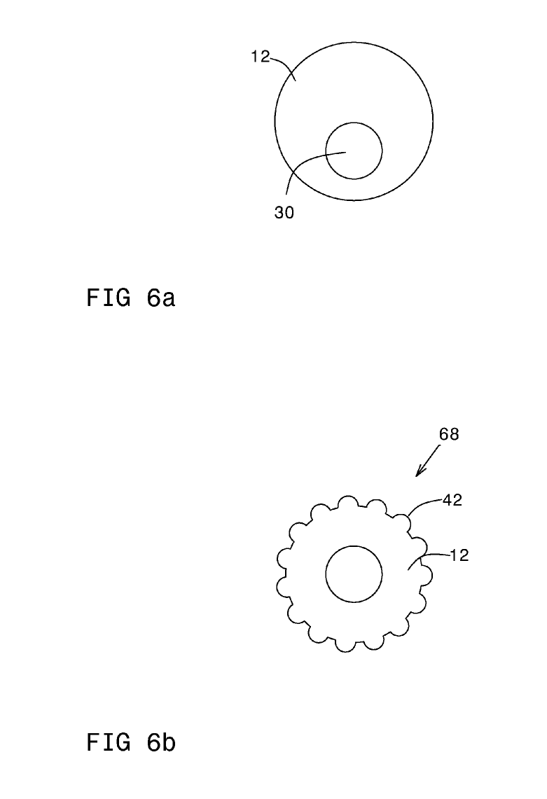

FIG. 6A depicts the cylinder of FIG. 1 according to one embodiment.

The external surface 68 of cylinder 12, contacting with bottom surface 70 of foot 60 may include one or more protrusions 42, for preventing free slipping of cylinder 12 along bottom surface 70 of foot 60, thus producing the linear physical pressure 64A or 64B on the bottom surface 70 of foot 60.

FIG. 6B depicts the cylinder of FIG. 1 according to another embodiment.

Cylinder 12 may have an axle 30 disposed away from the center, thus cylinder 12 is an eccentric cylinder, thus each roll of cylinder 12 produces a push on the bottom surface 70 of foot 60.

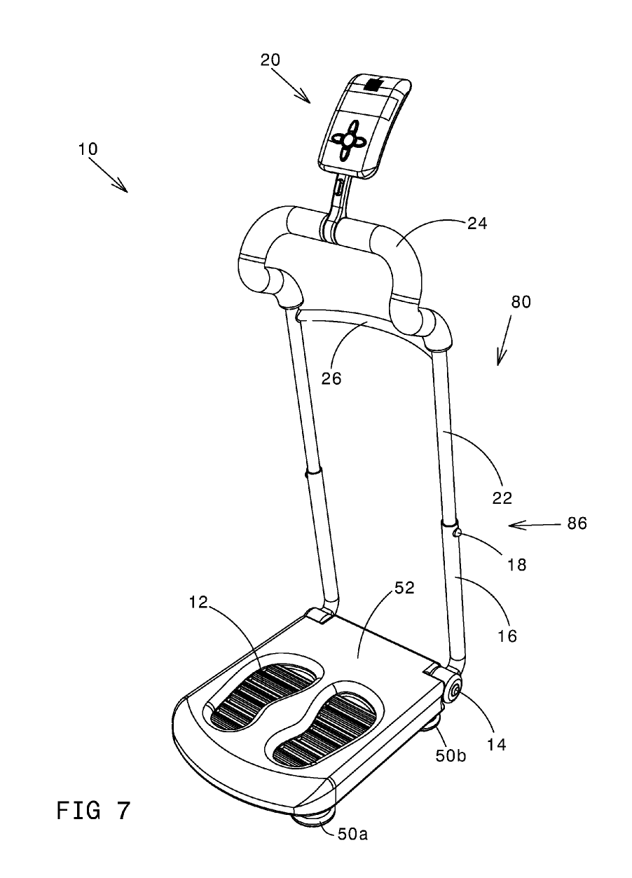

FIG. 7 is a perspective view of the body treatment device of FIG. 1.

Body treatment device 10 may include a folding mechanism 80, for folding handle 24 towards foot platform 52.

Folding mechanism 80 may include base 86 of handle 24 may include a bottom telescopic member 16; a top telescopic member 22; and a lock 18 in between.

A control unit 20 may controls motor 44 of FIG. 1 and controls the telescopes of supporting members 50A and 50B. Control unit 20 may be controlled manually, through a user interface, and/or automatically, such as through a timer, and as a function of the rotation direction of cylinders 12.

Control unit 20 via control module 88 thereof controls front member 50B of foot protection mechanism 36, to lift it and to lower rear member 50A only in case forward pushing 64A is produced by cylinders 12 rotated by cylinders rotating mechanism 38.

Control unit 20 via control module 88 thereof controls rear member 50A to lift it and to lower front member 50B only in case backward pushing 64B is produced by cylinders 12 rotated by cylinders rotating mechanism 38.

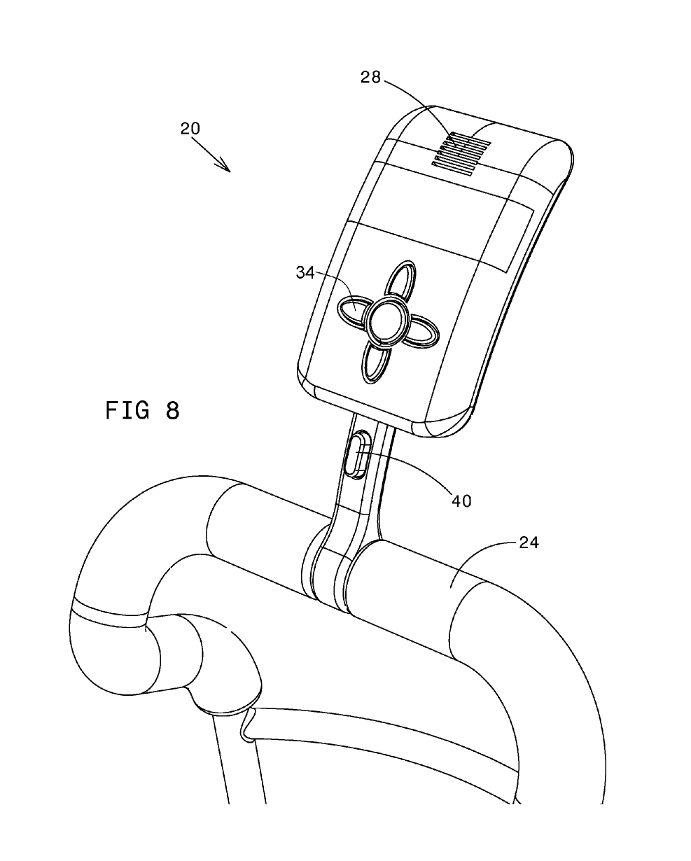

FIG. 8 is a perspective view of the body treatment device of FIG. 1.

Control unit 20 may include a user interface including buttons 34, a speaker 28, etc.

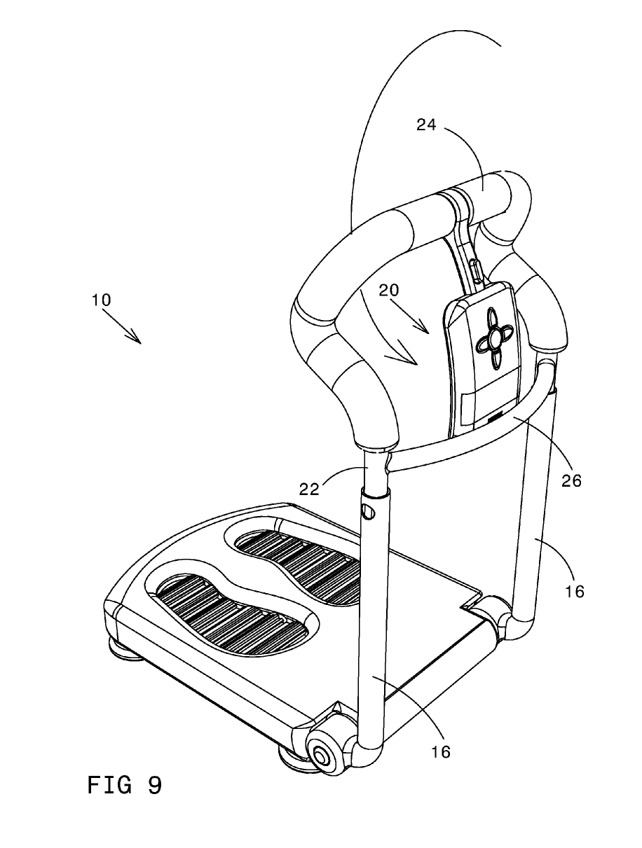

FIG. 9 is a perspective view of the body treatment device of FIG. 1 at a first folding step.

Thus, at the first step of folding, being opening lock 18, top telescopic member 22 may be inserted into bottom telescopic member 16. Also control unit 20 may be rotated by pressing physical button 40 (in FIG. 8).

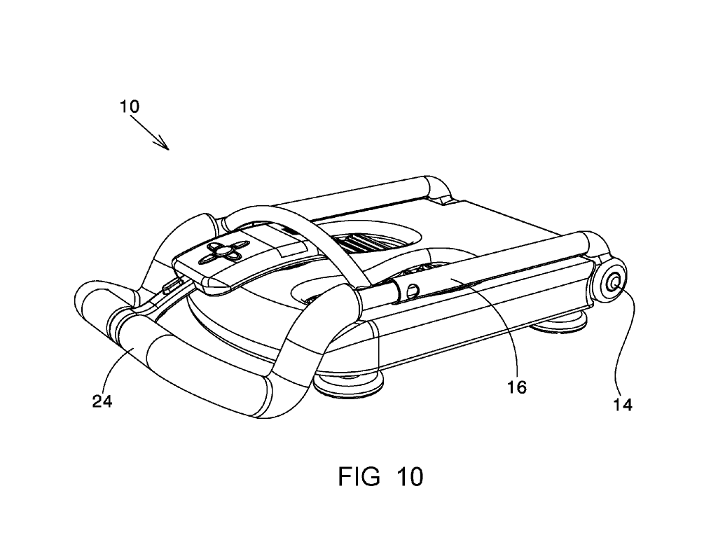

FIG. 10 is a perspective view of the body treatment device of FIG. 1 at the second folding step.

At the second folding step, pivotal connection 14 may be folded.

Thus, in one aspect, the invention is directed to a body treatment device (10) including:
a foot platform (52) including at least one depression (48), configured to place a user's foot (60) in each of the at least one depression (48) while standing;
a plurality of cylinders (12) disposed parallel to each other in the at least one depression (48), configured to place the foot (60) thereon in touch therewith;
a cylinders rotating mechanism (38), for rotating the plurality of cylinders (12), thereby pushing the foot (60) forward (64A) and backward (64B), one direction at a time, and further rotating the plurality of cylinders (12) in relation to the foot (60);
a foot protection mechanism (36) including a rear (50A) and front (50B) extendible supporting members (50A, 50B), for supporting a rear and front of the foot (60) respectively, for controllably tilting the foot platform (52); and
a control unit (20) including a control module (88), for controlling the foot protection mechanism (36) to tilt the foot platform (52),
   to lift the front (50B) extendible supporting member in relation to the rear (50B) extendible supporting member, thereby lifting the front of the foot (60) in relation to the rear thereof, thereby applying backward force (84A) on the foot (60) via gravity, in case the forward pushing (64A) is produced by the cylinders rotating mechanism (38), and
   to lift the rear (50A) extendible supporting member in relation to the front (50A) extendible supporting member, thereby lifting the rear of the foot (60) in relation to the front thereof, thereby applying forward force (84B) on the foot (60) via the gravity, in case the backward pushing (64B) is produced by the cylinders rotating mechanism (38),
      thereby the cylinders rotating mechanism (38) and foot protection mechanism (36) together are configured to rotate the plurality of cylinders (12) in relation to the foot (60), while the foot protection mechanism (36) prevents the foot (60) from being translated forward or backward with respect to the foot platform (52).

The cylinders rotating mechanism (38) may include a motor (44) and a strap (66), for physically communicating the motor (44) with the plurality of cylinders (12), thereby the plurality of cylinders (12) are rotatable along a rotational direction of the motor (44).

The body treatment device (10) may further include a handle (24), for allowing the user to hold by hands thereof.

The body treatment device (10) may further include a folding mechanism, for folding the handle (24) towards the foot platform (52).

Each of the plurality of cylinders (12) may include one or more protrusions (42) configured to prevent free slipping of the plurality of cylinders (12) along the bottom surface (70) of the foot (60).

Each of the plurality of cylinders (12) may be eccentric, being configured to prevent free slipping of the plurality of cylinders (12) along the bottom surface (70) of the foot (60).

The body treatment device (10) may further include a vibrator (46).

In the figures and/or description herein, the following reference numerals (Reference Signs List) have been mentioned:

numeral 10 denotes a body treatment device according to one embodiment of the present invention;
numeral 12 denotes a cylinder for producing physical flow on the bottom of the foot;
numeral 14 denotes a pivotal connection;
numeral 16 denotes a bottom telescopic member of the base of the handle;
numeral 18 denotes a lock, for not allowing folding the base of the handle;
numeral 20 denotes a control unit;
numeral 22 denotes a top telescopic member of the base of the handle;
numeral 24 denotes the handle;
numeral 26 denotes a bar;
numeral 28 denotes a speaker;
numeral 30 denotes an axle of the cylinder;
numeral 32 denotes a padding;
numeral 34 denotes a button;
numeral 36 denotes a foot protection mechanism, for protecting the front and the rear of the foot against pressure applied thereon;
numeral 38 denotes the cylinders rotating mechanism for rotating the cylinders along one direction against the weight applied thereon by the foot;
numeral 40 denotes a physical button;
numeral 42 denotes a protrusion in the cylinder;
numeral 44 denotes a motor for rotating the cylinders;
numeral 46 denotes a vibrator;
numeral 48 denotes a depression having the shape of the foot, for placing the foot therein;
numeral 50A denotes a rear extendible supporting member, for supporting and lifting the rear portion of the platform;
numeral 50B denotes a front extendible supporting member, for supporting and lifting the front portion of the platform;
numeral 52 denotes the platform, on which the user stands;
numeral 54 denotes a cog of the strap;
numeral 60 denotes a foot of the user;
numeral 62A denotes an angular motion of the wheel;
numeral 62B denotes the angular motion opposite to angular motion 62A;
numeral 64A denotes a linear pressure produced on the bottom surface of the foot by the angular motion 62A of the wheel;
numeral 64A denotes a linear pressure produced on the bottom surface of the foot by the angular motion 62B of the wheel;
numeral 66 denotes a strap, for transferring the rotation of the motor to the plurality of wheels;
numeral 68 denotes an external surface of the cylinder;
numeral 70 denotes the bottom surface of the foot;
numeral 72 denotes a gear or another surface of the cylinder, receiving the motion of the motor;
numeral 74 denotes a telescope of the supporting member;
numeral 76 denotes the rear portion of the platform;
numeral 78 denotes the front portion of the platform;
numeral 80 denotes a folding mechanism;
numerals 82A and 82B denote rear and front borders of the depression of the foot platform;
numeral 84A denotes gravity force applied on the foot pressing the foot backward;
numeral 84B denotes gravity force applied on the foot pressing the foot forward; and
numeral 86 denotes the base of the handle, for extending the handle from the foot platform.
numeral 88 of denotes the control module of control unit 20, for controlling supporting members 50A and 50B of foot protection mechanism 36.

The foregoing description and illustrations of the embodiments of the invention have been presented for the purpose of illustration, and are not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

What is claimed is:

1. A body treatment device (10) comprising:
a foot platform (52) comprising at least one depression (48), configured to place a user's foot (60) in each of said at least one depression (48) while standing;
a plurality of cylinders (12) disposed parallel to each other in said at least one depression (48), configured to place said foot (60) thereon in touch therewith;
a cylinders rotating mechanism (38) for rotating said plurality of cylinders (12), thereby pushing the foot (60) forward (64A) and backward (64B), one direction at a time, and further rotating said plurality of cylinders (12) in relation to the foot (60);
a foot protection mechanism (36) comprising a rear (50A) and front (50B) extendible supporting members (50A, 50B), for supporting a rear and front of the foot (60) respectively, for controllably tilting said foot platform (52); and
a control unit (20) comprising a control module (88), for controlling said foot protection mechanism (36) to tilt said foot platform (52),
to lift said front (50B) extendible supporting member in relation to said rear (50B) extendible supporting member, thereby lifting the front of the foot (60) in relation to the rear thereof, thereby applying backward force (84A) on the foot (60) via gravity, in case said forward pushing (64A) is produced by said cylinders rotating mechanism (38), and
to lift said rear (50A) extendible supporting member in relation to said front (50A) extendible supporting member, thereby lifting the rear of the foot (60) in relation to the front thereof, thereby applying forward force (84B) on the foot (60) via the gravity, in case said backward pushing (64B) is produced by said cylinders rotating mechanism (38),
thereby said cylinders rotating mechanism (38) and said foot protection mechanism (36) together are configured to rotate said plurality of cylinders (12) in relation to the foot (60), while said foot protection mechanism (36) prevents the foot (60) from being translated forward or backward with respect to said foot platform (52).

2. A body treatment device (10) according to claim 1, wherein said cylinders rotating mechanism (38) comprises:
a motor (44); and
a strap (66), for physically communicating said motor (44) with said plurality of cylinders (12),
thereby said plurality of cylinders (12) are rotatable along a rotational direction of said motor (44).

3. A body treatment device (10) according to claim 1, further comprising:
a handle (24), for allowing the user to hold by hands thereof

4. A body treatment device (10) according to claim 5, further comprising:
a folding mechanism, for folding said handle (24) towards said foot platform (52).

5. A body treatment device (10) according to claim 1, wherein each of said plurality of cylinders (12) comprises one or more protrusions (42) configured to prevent free slipping of said plurality of cylinders (12) along the bottom surface (70) of the foot (60).

6. A body treatment device (10) according to claim 1, wherein each of said plurality of cylinders (12) is eccentric, being configured to prevent free slipping of said plurality of cylinders (12) along the bottom surface (70) of the foot (60).

7. A body treatment device (10) according to claim 1, further comprising:
a vibrator (46).
